(19) United States
(12) Patent Application Publication
(10) Pub. No.: US 2019/0012717 A1
(43) Pub. Date: Jan. 10, 2019

(54) APPRATUS AND METHOD OF PROVIDING ONLINE SALES INFORMATION OF OFFLINE PRODUCT IN AUGMENTED REALITY

(71) Applicant: SK PLANET CO., LTD., Seongnam-si (KR)

(72) Inventors: Ju Hyeun HAN, Yongin-si (KR); Sang II NA, Seoul (KR); Su Bin LEE, Yongin-si (KR); Ji Min LEE, Yongin-si (KR)

(73) Assignee: SK Planet Co., Ltd.

(21) Appl. No.: 16/026,434

(22) Filed: Jul. 3, 2018

(30) Foreign Application Priority Data
Jul. 5, 2017 (KR) 10-2017-0085661

(51) Int. Cl. G06Q 30/06; G06T 19/00; G06F 17/30

(52) U.S. Cl. CPC G06Q 30/0627; G06F 17/30277; G06T 19/006; G06Q 30/0643

(57) ABSTRACT

A terminal device activates a camera function according to a user manipulation to capture an offline product image of an offline product and transmits the offline product image to a product information providing server to request online product sales information. The terminal device receives the online product sales information from product information providing server, and outputs the online product sales information with the offline product image in the augmented reality. The product information providing server receives the offline product image from the terminal device, and extracts offline product information by analyzing the received offline product image. The server searches the online product sales information corresponding to the extracted offline product information from an electronic commerce server, and provides the online product sales information to the terminal device.

### CROSS-REFERENCE TO RELATED APPLICATION

The present application claims priority to Korean Patent Application No. 10-2017-0085661 filed on Jul. 5, 2017, in the Korean Intellectual Property Office, which is incorporated herein in its entirety by reference.

### TECHNICAL FIELD

The present disclosure relates to an apparatus and method of providing online sales information of an offline product in augmented reality.

### BACKGROUND

The description in this section merely provides background information of embodiments of the present disclosure and is not intended to specify prior arts of the present disclosure.

Augmented reality, which is a field of virtual reality, is a computer graphics technique that combines a computer-generated virtual object with a real world environment to make the virtual object look like a real object existing in the real world environment.

The augmented reality allows to reinforce supplementary information in a form that is difficult to implement in the real world or in the virtual environment by synthesizing the virtual object on the basis of the real world.

This augmented reality technology, which synthesizes the real world environment and the virtual object, allows the user to refer to the real world environment while viewing the virtual object and enhances utility of information and immersive perception. For example, the user of a smartphone may add a location of a nearby shop, a telephone number of the shop, and the like over a picture of the surroundings of the user to be displayed in a three-dimensional image.

The augmented reality can be applied to various types of services, and user needs for various services based on the augmented reality is increasing explosively. Therefore, it is necessary to develop service functions that are more user-friendly and can satisfy the user needs.

On the other hand, when a user who happens to be interested in a certain product displayed in a store or worn or carried by another person and wants to know more detailed information about the product, the user typically has to search the product by inputting all the clue information of the product. This is because it is not easy to thoroughly view the product displayed in the shop in a state that a purchasing decision of the product is not made yet or to inquire the information about the product to the owner of the product.

### SUMMARY

To solve the problems above, provided are a method and apparatus for allowing the user to intuitively view product information such as a price of the product in augmented reality simply by capturing an image of the product and to receive an ordering or shopping cart page if the user intends to purchase the product.

Additional aspects will be set forth in part in the description which follows and, in part, will be apparent from the description, or may be learned by practice of the presented exemplary embodiments.

According to an embodiment of the present disclosure, a system for providing product sales information based on augmented reality may include a terminal device and a product information providing server. The terminal device may have a wireless communication function and a camera function. In addition, the terminal device may be configured to activate the camera function according to a user manipulation to capture an offline product image of an offline product, transmit the offline product image to a product information providing server to request online product sales information, receive the online product sales information from product information providing server, output the online product sales information with the offline product image in the augmented reality. The product information providing server may be configured to receive the offline product image from the terminal device, extract offline product information by analyzing the received offline product image, search the online product sales information corresponding to the extracted offline product information from an electronic commerce server, and provide the online product sales information to the terminal device.

When the product information providing server receives a user's selection of an online-sold product indicated in the online product sales information from the terminal device after providing the online product sales information, the product information providing server may provide the terminal device with a product purchasing page or a shopping cart page for the selected online-sold product in cooperation with the electronic commerce server.

According to an embodiment of the present disclosure, a product information providing server may include a service communication unit, a service search unit, and a service controller. The service communication unit may be configured to transmit and receive data to and from at least one terminal device and at least one electronic commerce server through a communication network. The service search unit may be configured to extract offline product information by analyzing an offline product image of an offline product, and acquire online product sales information corresponding to the extracted offline product information. The service controller may be configured to control the service search unit to perform an image-based search to find the online-sold product corresponding to the offline product when the offline product image is received from the terminal device through the service communication unit, and provide the terminal device with the online product sales information acquired by the service search unit.

When the service controller receives a user's selection of an online-sold product indicated in the online product sales information from the terminal device after providing the online product sales information, the service controller may provide the terminal device with a product purchasing page or a shopping cart page for the online-sold product in cooperation with the electronic commerce server. The service search unit may extract at least one of characteristics information of the offline product image, trademark information contained in the offline product image, price information of the offline product, and color information of the offline product as the offline product information.

The product information providing server may further include a service storage unit configured to store characteristics information of images for one or more online-sold products sold by one or more electronic commerce servers through the communication network. The service search unit may search at least one online-sold product the same as or similar to the offline product by comparing the characteristics information of images of the online-sold products stored in the service storage unit with the offline product image, and acquire the sales information of the extracted online-sold product from the electronic commerce server.

According to an embodiment of the present disclosure, a terminal device may include a communication unit, a camera unit, an input unit, and a controller. The communication unit may be configured to transmit and receive data through a communication network. The camera unit may be configured to take a captured image in response to a control command. The input unit may be configured to receive a user command. The controller may be configured to activate the camera unit in response to the user command to take an offline product image of an offline product, transmit the offline product image to a product information providing server through the communication unit, receive online produce sales information corresponding to the offline product image from the product information providing server through the communication unit, and output the online produce sales information with the offline product image in augmented reality.

When outputting the sales information of the online-sold product in the augmented reality, the controller may arrange the sales information of the online-sold product based on the offline product image in a captured image containing the offline product image. A user interface allowing a user to select one item in the sales information of the online-sold products may be output in addition to the sales information of the online-sold product and the online-sold product. When an item in the sales information of the online-sold products is selected through the user interface, the controller may transmit selection information to the product information providing server, and receive and display a product purchasing page or a shopping cart page for a selected online-sold product.

According to an embodiment of the present disclosure, a method of providing product sales information based on augmented reality in a product information providing server accessible by a terminal device through a communication network may include receiving an offline product image of an offline product from the terminal device; extracting offline product information by analyzing the received offline product image; acquiring online product sales information corresponding to the extracted offline product information from at least one electronic commerce server; and providing the acquired online product sales information to the terminal device so that the terminal device outputs the online product sales information with the offline product image in the augmented reality.

According to an embodiment of the present disclosure, a method of providing product sales information based on augmented reality in a terminal device capable of accessing a product information providing server through a communication network may include activating a camera function according to a user command to take an offline product image of an offline product; transmitting the offline product image to a product information providing server; receiving online product sales information corresponding to the offline product image from the product information providing server; and outputting the online product sales information with the offline product image in the augmented reality.

The method may further include: providing a user interface allowing a user to select one item in the sales information of the online-sold products in the outputting operation in addition to the sales information of the online-sold product and the online-sold product, and transmitting selection information to the product information providing server when the user select an item in the sales information of the online-sold products through the user interface; and receiving, from the product information providing server, and displaying a product purchasing page or a shopping cart page for a selected online-sold product.

According to an embodiment of the present disclosure, provided is a non-transitory computer-readable storage medium in which a program is stored. When executed by a processor, the program causes the processor to perform the method of providing online product sales information based on augmented reality.

According to an embodiment of the present disclosure, provided is a program stored in a non-transitory computer-readable storage medium. When executed by a processor, the program causes the processor to perform the method of providing online product sales information based on augmented reality.

The present disclosure allows the user to acquire detailed product information simply by capturing an image of an offline product. Since the information of the product that is the same as or similar to the offline product is output along with the captured image of the offline product in the augmented reality, the user may intuitively compare the offline product with the online-sold products.

Also, the user may receive an ordering page or a shopping cart page for purchasing the online-sold product by selecting an item corresponding to the online-sold product on the screen providing the product information in the augmented reality.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 is a schematic block diagram of a system for providing product sales information based on augmented reality according to an embodiment of the present disclosure;

FIG. 2 is a flowchart illustrating a method of providing the product sales information based on augmented reality according to an embodiment of the present disclosure;

FIG. 3 is a block diagram of a product information providing server according to an embodiment of the present disclosure;

FIG. 4 is a flowchart illustrating an operation of the product information providing server according to an embodiment of the present disclosure;

FIG. 5 is a block diagram of a terminal device for providing the product sales information based on augmented reality according to an embodiment of the present disclosure;

FIG. 6 is a flowchart illustrating an operation of the terminal device for providing the product sales information based on augmented reality according to an embodiment of the present disclosure;

FIGS. 7A and 7B are exemplary product images in an offline real world of which online sales information are to be provided based on augmented reality;

FIGS. 8A and 8B are exemplary screenshots providing the product sales information based on augmented reality according to an embodiment of the present disclosure;

FIG. 9 is an exemplary screenshot of a page provided after an online shopping mall is selected according to an embodiment of the present disclosure; and

FIG. 10 is a block diagram illustrating an operating environment of a device for providing the product sales information based on augmented reality according to an embodiment of the present disclosure.

The drawings described herein are for illustration purposes only and are not intended to limit the scope of the present disclosure in any way.

### DETAILED DESCRIPTION

For a more clear understanding of the features and advantages of the present disclosure, the present disclosure will be described in detail with reference to the accompanied drawings.

In the following description and the accompanied drawings, detailed descriptions of well-known functions or configuration that may obscure the subject matter of the present disclosure will be omitted for simplicity. It is to be noted that the same components are designated by the same reference numerals throughout the drawings.

The terminologies including ordinal numbers such as “first” and “second” used to describe various elements in this specification may be used only to discriminate one element from another elements, but the terms do not restrict the structures of the elements.

It should be noted that the embodiments of the present disclosure described in the present specification and drawings are only illustrative of the present disclosure and are not intended to limit the scope of the present disclosure. It will be apparent to those skilled in the art that other modifications may be made based on the technical idea of the present disclosure in addition to the embodiments disclosed herein.

The terms and words used in the following description and drawings are not necessarily to be construed in an ordinary sense or a dictionary, and may be appropriately defined herein to be used as terms for describing the present disclosure in the best way possible. Such terms and words should be construed as meaning and concept consistent with the technical idea of the present disclosure.

When an element is referred to as being “connected” or “coupled” to another element, it means that it is logically or physically connected or it may be connected to the other element. In other words, it is to be understood that although an element may be directly connected or coupled to another element, there may be other elements therebetween, or element may be indirectly connected or coupled to the other element.

The terminology used herein is for the purpose of describing particular embodiments only and is not intended to be limiting of the disclosure. The singular forms include plural referents unless the context clearly dictates otherwise. Also, The expressions “˜ comprises,” “˜ includes,” “˜ constructed,” “˜ configured” are not to be construed as being equipped with all the components, processing steps, or operations described in this specification, but some of the components, the processing steps, or the operations may not be included and additional elements may be incorporated further.

The articles ‘a,’ ‘an,’ ‘the,’ ‘one,’ and their equivalents may be used in the sense of including both the singular and the plural meaning unless the context clearly indicates otherwise or is clearly contradicted by context in the context of describing the disclosure, particularly, in the context of the following claims.

Hereinbelow, described are a system and method of providing product sales information based on augmented reality according to an embodiment of the present disclosure with reference to the attached drawings.

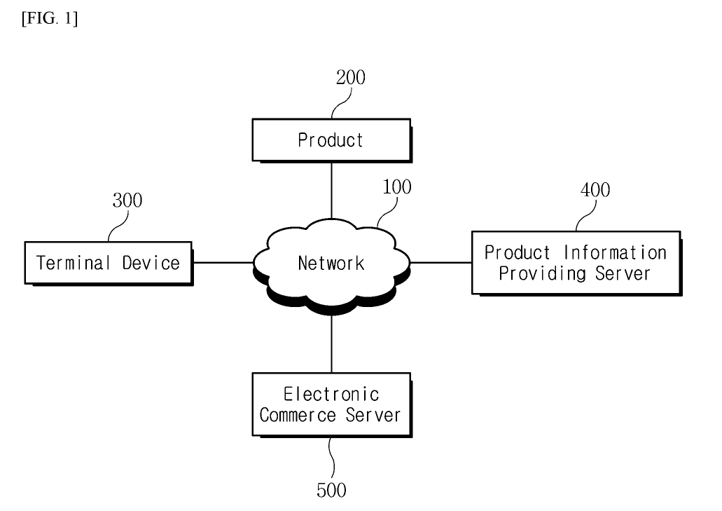

FIG. 1 is a schematic block diagram of a system for providing product sales information based on augmented reality according to an embodiment of the present disclosure. The system for providing the product sales information based on augmented reality may include a network 100, a terminal device 300, a product information providing server 400, and an electronic commerce server 500. A reference numeral 200 denotes a product existing in an offline real world (hereinbelow, referred to as “offline product”) of which information is to be provided online according to the present disclosure.

The network 100, which enables data transmission among the terminal device 300, the product information providing server 400, and the electronic commerce server 500, may serve as a transmission medium through which the terminal device 300 transmits a product appearance image taken by a camera of the terminal device 300 to the product information providing server 300 and receives product information requested by the terminal device 300 from the product information providing server 300. The type of network 100 is not limited to particular ones.

For example, the network 100 may include a wireless network such as wireless local area network (WLAN), Wi-Fi, wireless broadband Internet (Wibro), Worldwide Interoperability for Microwave Access (WiMAX), and High Speed Downlink Packet Access (HSDPA). However, the present disclosure is not limited thereto, but the network 100 may include a wired network such as Ethernet, Digital Subscriber Line (xDSL) such as Asymmetric Digital Subscriber Line (ADSL) and Very High Bitrate Digital Subscriber Line (VDSL), Hybrid Fiber Coaxial Cable (HFC), Fiber-to-the-Curb (FTTC), and fiber-to-the-home (FTTH).

Also, the network 100 may include a mobile communication network comprised of a plurality of access networks (not shown) and a core network (not shown) connecting the plurality of access networks. The access networks, which allow the terminal device 300 to be connected to the core network for wireless communications, may include a plurality of base stations such as a traditional base station (BS), a base transceiver station (BTS), a Node B (or NodeB), an Evolved Node B (eNodeB), and a plurality of base station controllers such as a traditional Base Station Controller (BSC) and a Radio Network Controller (RNC). Meanwhile, a digital signal processing unit and a radio signal processing unit which may be integrally implemented in the base station may be reorganized into a digital unit (DU) and a radio unit (RU), so that each of a plurality of the RUs are provided in respective one of a plurality of areas, and the plurality of RUs are connected to a centralized DU.

The core network, which performs main functions for mobile communication services such as mobility control and switching among terminal devices, performs circuit switching or packet switching operations, and manages and controls packet flow in the mobile communication network. Also, the core network manages inter-frequency mobility and may play a role for interworking traffics in the access network and the core network with another network such as Internet. The core network may further include at least one of: a Serving Gateway (SGW), a Packet Data Network (PDN) Gateway, a Mobile Switching Center (MSC), a Home Location Register (HLR), a Mobile Management (MME), and a Home Subscriber Server (HSS).

Also, the network 100 according to the present disclosure may include the Internet. The Internet refers to a open network or a public network that allows information exchange according to a TCP/IP protocol.

The terminal device 300, the product information providing server 400, and the electronic commerce server 500 may interoperate with each other through the network 100 to provide the service of providing the product sales information based on augmented reality of the present disclosure.

In the present disclosure, the product 200 corresponds to an actual product of which image is captured by a user who wishes to compare the image with online-sold product information. Also, the product 200 may serve as a source for collecting product information to a service provider who acquires product information to store in the product information providing server 400.

The product 200 may be one worn by or carried by other people on the street, for example, or may be one displayed in an offline store.

The product 200 may exist alone for itself, but may include a tag in case that, for example, the product is displayed in the offline store.

The terminal device 300 may include a camera for shooting the product 200.

Also, the terminal device 300 may store and execute an application program provided by the product information providing server 400 to transmit a captured product image to the product information providing server 400 and request information about the product from the product information providing server 400.

Further, the terminal device 300 may include a display screen to output online sales information of the product 200 provided by the product information providing server 400 through the display screen in the augmented reality.

The terminal device 300 may be implemented in various forms.

Preferably, the terminal device 300 is capable of wireless communications and equipped with the camera. However, terminal device 300 is not limited thereto but may be one of various terminals such as a smartphone, a portable terminal, a mobile terminal, a personal digital assistant (PDA), a portable multimedia player (PMP) terminal, a telematics terminal, a navigation terminal, a personal computer (PC), a notebook computer, a slate PC, a tablet PC, an ultrabook, a wearable device such as a smart watch and a smart glass, a head-mounted display (HMD), a Wibro terminal, an Internet Protocol television (IPTV) terminal, a smart TV, a digital broadcast receiver terminal, an audio-video navigation (AVN) terminal, an audio/video (NV) system, and a flexible terminal.

Even though it is impossible to enumerate all types of the terminal device 300 considering convergence trend of digital devices, any device unit equivalent to the device units mentioned above may be used as the terminal device 300. Also, any device unit capable of communicating with the product information providing server 400 through the network 100 may be used as the terminal device 300 according to the present disclosure. In addition, the terminal device 300 may be a device currently available as well as any other device that may be developed in the future and has a communications capability. Although just a single terminal device 300 is shown in FIG. 1, there may be a plurality of terminal devices 300, in the system, that communicate with the product information providing server 400.

The product information providing server 400 acquires online sales information of the product 200, which represents sales information at one or more electronic commerce servers 500 connected to the network 100, according to a request of the terminal device 300 to provide to the terminal device 300.

The product information providing server 400 may acquire the online sales information of the product 200 in advance and store the online sales information into a database before the user of the terminal device 300 requests the information by capturing an image of the product 200 existing in an offline physical world. The product information providing server 400 may store detailed information of the product 200, along with its similar products, in the database based on the image of the product, so that the product information providing server 400 may provide the terminal device 300 with the stored information when the user of the terminal device 300 requests the information by capturing the image of the product 200 existing in the offline physical world. For this purpose, the product information providing server 400 may store, in the database, the detailed information of the product including two-dimensional or three-dimensional image, manufacturing or production information, a price, a size, a color, a material, a user manual, history information, an average delivery time, quantities in stock of the product, and the like.

Also, the product information providing server 400 may transmit the product information acquired from the electronic commerce server 500 to the terminal device 300 without storing into the database.

The product information providing server 400 may be implemented integrally with a commerce server, for example, operating in an online shopping mall system or an open market system. Alternatively, the product information providing server 400 may be provided in a form of a separate server that performs the functions described above in association with the online shopping mall server. In addition, the information providing server 400 may distribute an application program that performs the above functions.

According to the present disclosure, the application program may be a product purchase application suitable for performing a product purchase process.

The application program may be downloaded from a server (e.g., an application store server) which mediates downloading of applications between the terminal device 300 and the information providing server 400. The information providing server 400 may register the application program in the application store server (not shown) when the application program suitable for achieving the above purpose is created and is to be distributed, and the terminal device 300 may download the application program from the application store server through the network 100.

The electronic commerce server 500 is a device that sells the product 200, through the network 100, of which information is provided by the product information providing server 400 to the terminal 200, and may be a commerce server of the open market system that brokers transactions between sellers and consumers, an online shopping mall organized by a seller, or a joint purchasing social commerce system.

The product information provided by the product information providing server 400 to the terminal device 300 may include information on online shopping malls selling the product 200 and price comparison information among the shopping malls. When the user of the terminal device 300 selects and accesses a certain online shopping mall, the electronic commerce server 500 may provide a page containing a detailed description of the product 200 to the terminal 300 and then provide a page for ordering the product or a shopping cart page to the terminal device 300.

The configurations and operations of the terminal device 300 and the product information providing server 400 will be described below in detail. A processor mounted in each device according to an embodiment of the present disclosure may execute program instructions for performing the method according to the present disclosure. The processor may be a single-threaded processor. Alternatively, however, the processor may be a multithreaded processor. The program instructions executed by the processor may be stored in a memory or a storage device.

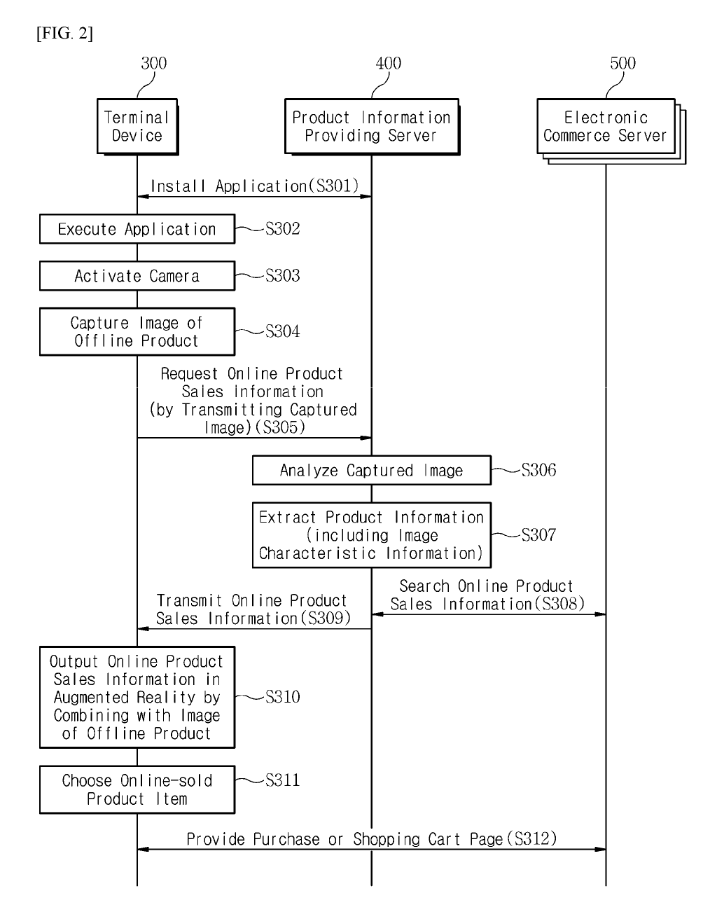

FIG. 2 is a flowchart illustrating a method of providing the product sales information based on augmented reality according to an embodiment of the present disclosure.

Referring to FIG. 2, the terminal device 300 may install and execute the application program for providing online product sales information based on the augmented reality according to the present disclosure (S301, S302).

The application program which may be distributed by the product information providing server 400 may facilitate the user of the terminal device 300 to use an electronic commerce service by performing transactions with the electronic commerce server 500. The application program may perform a product purchasing process, which may include again a product search process, a product selection process, and an ordering and payment process.

While the application is being executed, the camera of the terminal device 300 may be activated in response to a selection input of the user (S303). Alternatively, the camera may be activated automatically at the same time as the execution of the application program according to a setting of the application program.

The user of the terminal device 300 may capture the image of the offline product by use of the terminal device 300 of which camera is activated (S304). Here, the capturing the image of the offline product may include a process of placing the terminal device 300 such that the offline product 200 is located within a predetermined frame of the camera, and may include a process of pressing a shooting button of the camera. At this time, a separate guide line may be displayed on the activated camera to facilitate positioning of the offline product 200 within the frame of the camera, and the user may move the terminal device 300 such that the offline product 200 resides safely within the frame along with the guide line.

After the image of the offline product 200 is captured through such a process, the terminal device 300 may transmit the image of the offline product 200 to the product information providing server 400, so that the product information providing server 400 may recognize the offline product (S305). The recognition of the offline product may include an operation of recognizing a product image itself of the offline product or a trademark attached on the offline product. Also, the recognition of the offline product may include an operation of recognizing a tag attached on the offline product in case of a product displayed in a shop.

The terminal device 300 may request online product sales information corresponding to the offline product from the product information providing server 400 by transmitting the image of the offline product.

Subsequently, the product information providing server 400 may analyze the product image received from the terminal device 300, recognize the offline product, and extract the offline product information (S306, S307). Here, the recognition of the offline product through the image analysis of the offline product may include at least one of: an extraction of image characteristic information of the offline product, a detection of the trademark attached on the product, and a detection of the tag attached on the product. The detected information may be used as the product information.

The product information providing server 400 may construct a database of various products that are sold online and offline. A see-through type head mounted display (HMD) or a three-dimensional scanner capable of acquiring a three-dimensional geometry, a length, a shape, or a color of the offline product may be utilized in the acquisition of the information about the products in building the database. The acquired product information may include the image, the size, the color, or the material of the product.

Afterwards, the product information providing server 400 having received the product information providing request from the terminal device 300 may identify the offline product in the image by searching the database for detailed information of the products the same as or similar to the offline product based on the extracted product information.

Here, the product information providing server 400 may use an image matching technique or a near duplicate image detection (NDID) technique to search for the products being the same as or similar to the offline products.

In detail, the image matching technique refers to an algorithm for automatically extracting coordinates of conjugate points from two images being compared. Area-based image matching methods may be most typical image matching techniques. A correlation coefficient image matching method among the area-based image matching methods is a most basic method of finding the conjugate points using a similarity of the grey levels of the two images. A least squares image matching method, which allows a matching result of an accuracy of a subpixel unit compared with existing image matching methods having an accuracy of a pixel unit, shows a good result when the position of the matching points exist within two or three pixels. Therefore, the least squares method is used to obtain a higher accuracy after using the correlation coefficient method.

Feature-based image matching uses points, lines, or plane features for matching two images. A feature point matching method using the feature points extracts feature points by using operators such as Forstner and Moravec and performs the correlation coefficient matching by using the feature points as seed points. Feature line matching method extracts various boundaries from the images and performs the image matching based on the extracted boundaries. A differential operator such as Laplacian of Gaussian (LoG) operator is used as a method of extracting the boundaries. Meanwhile, plane feature matching method performs the image matching by extracting polygons from the images.

Relational matching methods find best correspondences between images or structures. Most common relational matching methods use tree structures. According to the methods, the features such as points, lines, and plane figures are extracted from the images, classified into tree structures, and stored in a database. If a feature is selected in one image, the position of a corresponding feature in the other image is retrieved from the database.

Digital elevation model (DEM) may be generated by using a digital map, images or photographs, or an analytical model. In the generation of the digital elevation model using the digital map, vertices may be extracted using a numerical map of a scale of 1/5,000 or 1/1,000 and interpolation is carried out between the vertices. Generally, the method is one of the easiest way to make the digital elevation model and guaranteed an accuracy to some extent. The generation of the digital elevation model using the images or photographs generates the digital elevation model through the image matching, but the digital elevation model may be obtained only for overlapping areas. The generation of the digital elevation model by the analytical method generates the digital elevation model by collecting three-dimensional coordinates and interpolating points between the coordinates by an analytical model.

The near duplicate image detection technique is designed to scan large amounts of digital images and cluster the scanned images. Then, the user may automatically remove duplicate images through a duplicate detection feature. Generally, the near duplicate image detection technique may further include an operation of applying a feature determination function to a plurality of images—where features are defined by geometric shapes and where, if to a certain ratio of the features of at least two images matches characteristics of the geometric shapes defining the features, at least two of the plurality of images are characterized by duplicate matching.

This method generally includes analyzing the content of the images being compared and generating color and texture histogram descriptor data for each image. Then, the images may be compared based on the color and texture histogram descriptor data to determine whether the images are near a duplicate image. The content-based image signature data may also be generated for each image based on the color and texture histogram descriptor data. The image signature data may then be compared to determine if the corresponding images are near the duplicate image.

When the recognition of the product being the same as or similar to the offline product is completed, the product information providing server 400 may acquire information on the recognized product. To this end, the product information providing server 400 may extract characteristics of the images of products sold in the online shopping mall and store them in the database in advance. Also, the product information providing server 400 may include a system for extracting the characteristics of the image of the offline product when the image of the offline product is received and searching the database for an image which is the same as or similar to the offline product.

In case that the product information providing server 400 does not have the database for storing the images of the online-sold products or cannot find the image which is the same as or similar to the offline product, the product information providing server 400 may request the electronic commerce server 500 to search for sales information on the same product as the offline product (S308).

The product information providing server 400 may transmit the online product sales information found in the database or received from the electronic commerce server 500 in operation S308 to the terminal device 300 (S309). The product sales information may include a name, the color, and the size of the product, online shopping mall information on sale, the price of the product, the quantities in stock, and the like.

Afterwards, the terminal device 300 may receive the online product sales information from the product information providing server 400 and outputs the online product sales information in the augmented reality by combining with the captured image of the offline product (S310). The online product sales information output in the augmented reality may include detailed information on the product as well as a list of online shopping malls selling the product.

At this time, the user of the terminal device 300 may input desired price, color, or size of the online-sold products, so that only the information of the desired products among vast products are selectively displayed.

Next, the user of the terminal device 300 may select any item in the shopping mall list to check more detailed information about the product or purchase the product (S311). If the user selects one item in the shopping mall list, the terminal device 300 may display a detailed information page for the product or an ordering page or a shopping cart page where the user can order the product (S312).

As described above, an embodiment of the present disclosure allows the user of the terminal device 300 to receive the information of the products the same as or similar to the offline product by intuitively capturing the image of the offline product without having to input the specifications of the offline product, and outputs the online-sold product information in the augmented reality so that the user can conveniently check the realistic contents of the offline product.

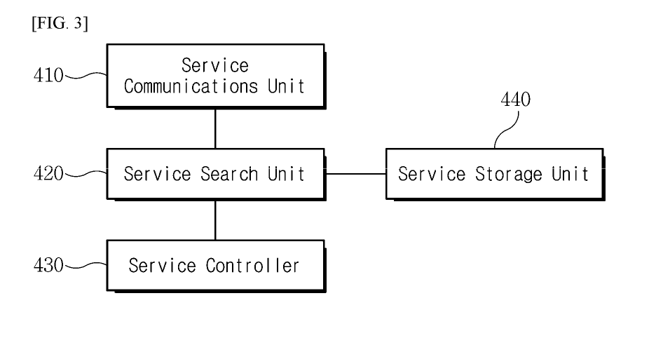

FIG. 3 is a block diagram of the product information providing server 400 according to an embodiment of the present disclosure.

Referring to FIG. 3, the product information providing server 400 according to an embodiment of the present disclosure includes a service communication unit 410, a service search unit 420, a service controller 430, and a service storage unit 440.

It should be noted that FIG. 3 schematically illustrates basic and essential components of the product information providing server 400 according to the present disclosure, and the product information providing server 400 may further include other components than those shown in FIG. 3 as needed.

The service communication unit 410, the service search unit 420, the service controller 430, the service storage unit 440 may be implemented by computer software, firmware, hardware, or a combination of one or more of these.

The service communication unit 410, which communicates with the terminal device 300 and the electronic commerce server 500 through the network 100, enables interfacing with a link server of an online shopping mall system, for example, and may support transmission and receipt of information necessary for the provision of product information according to the present disclosure.

The network 100 may be a wireless network adopting a wireless communication scheme such as wireless local area network (WLAN), Wi-Fi, wireless broadband Internet (Wibro), Worldwide Interoperability for Microwave Access (WiMAX), and High Speed Downlink Packet Access (HSDPA). However, the present disclosure is not limited thereto, but the network 100 may be a wired network adopting a communication scheme such as Ethernet, Digital Subscriber Line (xDSL) such as Asymmetric Digital Subscriber Line (ADSL) and Very High Bitrate Digital Subscriber Line (VDSL), Hybrid Fiber Coaxial Cable (HFC), Fiber-to-the-Curb (FTTC), and fiber-to-the-home (FTTH).

However, the present disclosure is not limited thereto, but the network 100 may be implemented based on another communication scheme that is already available or may be developed in the future.

The service search unit 420 analyzes the product image received from the terminal device 300 to acquire at least one of product information such as characteristic information of the product image, trademark information included in the product image, the price of the offline product, and the color of the offline product. Here, the service search unit 420 may perform the image matching or the near duplicate image detection (NDID) technique to acquire the product information. Meanwhile, the service search unit 420 may collect the characteristic information of the image of the online-sold product which is sold at the electronic commerce server 500 through the network 100 to store in the service storage unit 440.

The service storage unit 440 stores the characteristic information of the image of at least one online-sold product which is sold at the electronic commerce server 500 through the network 100. Here, the service search unit 420 may search for the online-sold product the same as or similar to the offline product by comparing the characteristic information of the image of the offline product with the characteristic information of the images of the online-sold products and extract the online sales information of the product from the electronic commerce server 500.

The service controller 430 performs overall control of the product information providing server 400, and may include an operating system and a processor device configured to analyze the characteristic information of the image of the offline product received from the terminal device 300 and retrieve the online-sold product the same as or similar to the offline product.

The service controller 430 may control an overall process of analyzing the captured image of the offline product received from the terminal device 300, extracting the characteristic information of the image of the offline product, searching at least one online-sold product corresponding to the extracted information, and requesting information of the extracted product from the electronic commerce server 500.

Also, when the user of the terminal device 300 intends to receive detailed information about the product or purchase the product, the service controller 430 may request a corresponding shopping mall to provide the terminal device 300 with a page containing the detailed information of the product or a page for ordering the product or a shopping cart page. In addition, after the offline product is identified, the service controller 430 may retrieve, from the database, the detailed information of the identified product including the two-dimensional or three-dimensional image, the manufacturing or production information, the price, the size, the color, the material, the user manual, the history information, the average delivery time, the quantities in stock of the product, and the like to transmit to the terminal device 300. Alternatively, the service controller 430 may receive the information of the identified product from the electronic commerce server 500 to provide to terminal device 300.

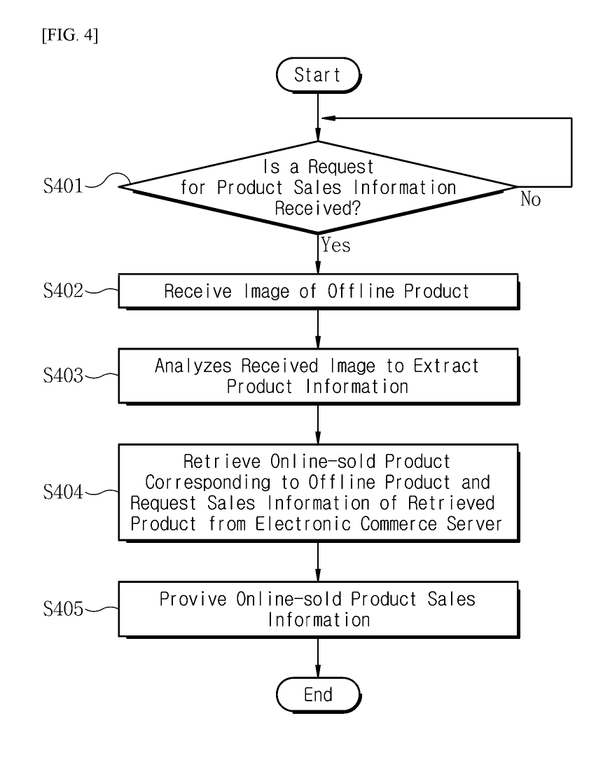

FIG. 4 is a flowchart illustrating an operation of the product information providing server 400 according to an embodiment of the present disclosure.

The service of providing the product sales information based on the augmented reality according to the present disclosure, which is provided by the product information providing server 400 with a support of the electronic commerce server 500, can be more easily understood by the description of the operation of the product information providing server 400 described below.

Referring to FIG. 4, the product information providing server 400 checks whether a request for the product sales information for the offline product captured by the terminal device 300 is received from the terminal device 300 (S401).

When the request is received from the terminal device 300, the product information providing server 400 receives the image of the offline product captured by the terminal device 300 (S402) and analyzes the received image to extract the product information (S403).

At this time, the trademark attached on the offline product may be extracted in addition to the product image itself. Further, in case that the offline product is displayed in the offline store, the tag attached on the offline product may be extracted and analyzed additionally.

The image matching technique or the near duplicate image detection (NDID) technique may be utilized in the analysis of the image.

To this end, the product information providing server 400 may extract characteristics of the images of products sold in the online shopping mall and store them in the database in advance. Also, the product information providing server 400 may include a system for extracting the characteristics of the image of the offline product when the image of the offline product is received and searching the database for an image which is the same as or similar to the offline product.

The extracted product information may include detailed information of the product such as the name, the trademark, the manufacturer, the product number, the color, and the size of the product.

Subsequently, the product information providing server 400 may retrieve, from the database, the information of the online-sold product which is the same as or similar to the offline product extracted in the operation S403. In case that the product information providing server 400 does not have the database for storing the images of the online-sold products or cannot find the online-sold product which is the same as or similar to the offline product, the product information providing server 400 may request the electronic commerce server 500 to search for the online-sold produce the same as or similar to the offline product.

Afterwards, the product information providing server 400 may request the electronic commerce server 500 to provide the sales information of the retrieved online-sold product and receive the information from the electronic commerce server 500 (S404).

Next, the sales information of the retrieved online-sold product acquired in the operation S404 which is the same as or similar to the offline product is provided to the terminal device 300 (S405). The sales information of the online-sold product may include the name, the manufacturer, the product number, the color, and the size of the product, and a list of online shopping malls selling the product.

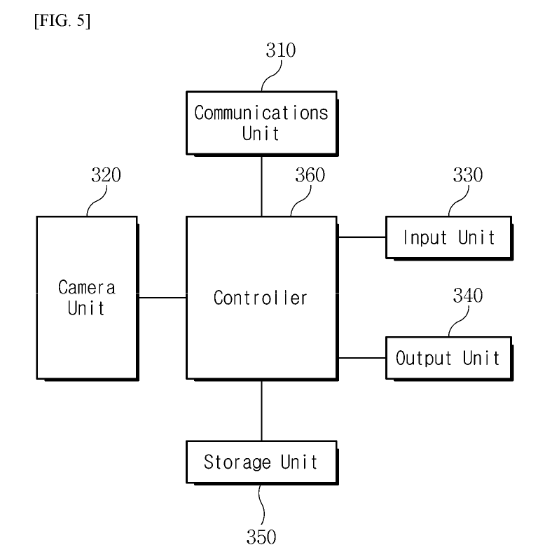

FIG. 5 is a block diagram of the terminal device 300 for providing the product sales information based on the augmented reality according to an embodiment of the present disclosure.

Referring to FIG. 5, the terminal device 300 may include a communication unit 310, a camera unit 320, an input unit 330, an output unit 340, a storage unit 350, and a controller 360.

It should be noted that FIG. 5 schematically illustrates basic components of the terminal device 300 according to the present disclosure, and the terminal device 300 may further include other components than those shown in FIG. 3 as needed.

The communication unit 310 transmits and receives data to and from external devices through the network 100. In particular, the communication unit 310 communicates with the product information providing server 400 through the network 100 to transmit the captured image of the offline product and product information extracted from the captured image for the offline product, and transmits and receives other data needed for providing the product sales information according to the present disclosure.

The communication unit 310 may include at least one of a wireless communication module (not shown) and a wired communication module (not shown).

The wireless communication module, which enables the data transmission through the network adopting the wireless communication scheme, may include at least one of a mobile communication module, a wireless LAN communication module, and a wireless personal area network (PAN) so that the terminal device 300 may transmits data to the product information providing server 400 through at least one of such modules.

The wired communication module, which enables the data transmission through a wired channel, may access the network 100 through the wired channel to transmit data to the product information providing server 400.

The camera unit 320 may include a front camera and a rear camera. The camera unit 320 may be activated by the user or by the application program for the user to capture the offline product image.

At this time, in order that an outline or trademark of the product may be recognized easily, a guide line may be displayed on the activated camera to facilitate positioning of the outline or trademark within the frame of the camera. Thus, the user may move the terminal device 300 such that the outline or trademark resides safely within the frame along with the guide mark.

The input unit 330 generates a user input signal in response to a touch input or manipulation input of the user.

For example, the input unit 330 may receive an input for activating or operating the camera unit for capturing the offline product image, an input for accessing a certain online shopping mall by use of product sales information which the terminal device 300 received from the product information providing server 400, and an input for filtering the received information according to a criterion designated by the user.

The input unit 330 may be implemented by a variety of input devices. For example, the input unit 330 may include at least one of a key input device, a touch input device, a gesture input device, and a voice input device. The key input device may include a keypad or a keyboard having a plurality of keys and generate a signal corresponding to each of the plurality of keys when the key is manipulated by the user. The touch input device may be a touch pad, a touch screen, or a touch sensor, which recognize an input operation by sensing the user's touch of a specific portion. The gesture input device may include at least one of: a geomagnetic sensor, an acceleration sensor, a camera, an altimeter, a gyro sensor, and a proximity sensor to detect and recognize a predetermined movement or gesture of the user such as a shaking or moving of the terminal device, an approach to the terminal device, an eye blinking, or the like as a specific input signal.

The output unit 340 may output a series of operating states and operation results during the operation of the terminal device 300 under a control of the controller 360. In particular, according to the present disclosure, the output unit 340 outputs the product information corresponding to the offline product image captured by the user in the augmented reality so that the user can realistically perceive the product information.

The output unit 340 may be implemented by a display device such as a liquid crystal display (LCD), a thin film transistor LCD (TFT-LCD), a light emitting diode (LED), an organic light emitting diode (OLED), an active-matrix organic light emitting diode (AMOLED), a flexible display, or a three-dimensional display.

Also, the output unit 340 may include a audio output unit. The audio output unit may output audio information included in a signal processed by the controller 360. The audio output unit may include a receiver, a speaker, and a buzzer to output a guidance sound generated by the controller 360.

The input unit 330 and the output unit 340 may be incorporated into a single touch panel screen that may perform both the input and output functions.

Through the above-described configuration, the terminal device 300 may receive the product information from the product information providing server 400 to provide the information to the user in the augmented reality. During this operation, the terminal device 300 may store the captured image of the offline product and data received from the product information providing server 400 into the storage unit 350.

The storage unit 350, which is a device for storing data, includes a main memory device and an auxiliary storage device and stores an application program required for the functional operation of the terminal device 300 and data required for the running of the program. The storage unit 350 may include a program area and a data area.

In particular, the storage unit 350 according to the present disclosure may store the application program which is distributed by the product information providing server 400 and downloaded from the application store server (not shown). Also, the storage unit 350 may further store a program for analyzing the product image.

The storage unit 350 may include a storage medium such as a random access memory (RAM), a read-only memory (ROM), a hard disk (HDD), a flash memory, a compact disc read-only memory (CD-ROM), and a digital versatile disc (DVD) as well as other storage medium such as a network access storage (NAS).

The controller 360 may be a processor device which executes the operating system and each configuration of the terminal device 300.

The controller 360 controls overall operations of the terminal device 300 including the execution of the application program stored in the storage unit 350 for providing the user with the product sales information received from the product information providing server 400.

In particular, the controller 360 may control the process of combining the online product sales information received from the information providing server 400 with the captured image of the offline product to output in the augmented reality.

Also, when receiving the captured image of the offline product from the camera unit 320, the controller 360 controls the process of transmitting the request for the information of the online-sold product the same as or similar to the offline product to the product information providing server 400 through the application program.

The application according to the present disclosure executed by the controller 360 may receive the list of online-sold products corresponding to offline product from the product information providing server 400 and output the list of the online-sold products to induce the user to select a certain item in the list.

The controller 360 may perform a change the image output in the augmented reality such as a rotation and a modification of the image according to an instruction of the user.

The controller 360 may include a RAM, a ROM, a CPU, and a GPU, which may be connected to each other by a bus. The CPU may access the storage unit 350 to read out the operating system stored in the storage unit 350 and boot the terminal device 300, and perform various operations using the programs, contents, and data stored in the storage unit 350.

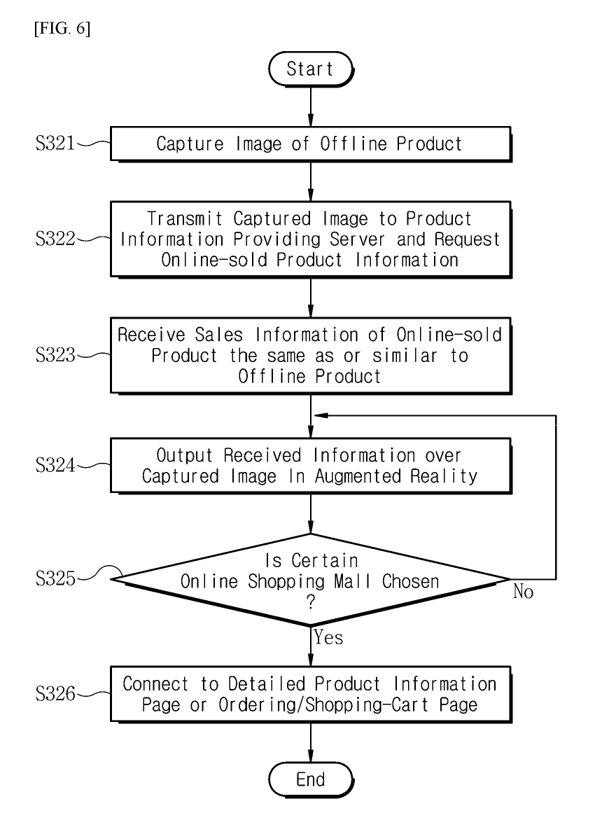

FIG. 6 is a flowchart illustrating the operation of the terminal device 300 for providing the product sales information based on the augmented reality according to an embodiment of the present disclosure.

Referring to FIG. 6, the terminal device 300 captures the image of the offline product according to the user's manipulation (S321). At this time, the camera unit 320 may be operated by the application program installed in the terminal device 300 in advance. The offline product being captured may be one worn by or carried by other people on the street or may be one displayed in an offline store.

Subsequently, the terminal device 300 transmits the captured image of the offline product to the product information providing server 400 through the network 100 and requests information about an online-sold product the same as or similar to the offline product (S322).

The product information providing server 400 may use the image matching technique or the near duplicate image detection (NDID) technique to retrieve the online-sold product the same as or similar to the offline product. The product information providing server 400 may determine the online-sold product by comparing the captured image received from the terminal device 300 with the product information retrieved from the database or received from the electronic commerce server 500.

Afterwards, the terminal device 300 receives, from the product information providing server 400, sales information of the online-sold product which is the same as or similar to the offline product (S323). The product sales information from the product information providing server 400 may include the price and color of the product and a list of online shopping malls and open markets selling the product. At this time, the user may designate conditions on the price, color, size of the desired product to narrow down the search result of the product sales information.

The terminal device 300 may combine the received information with the captured image of the offline product in real time to output in the augmented reality. The terminal device 300 may arrange the images of the offline product and the online-sold product to be close with each other, so that the user can intuitively compare the images and utilize the product sales information in a purchase decision-making.

When the user needs more detailed information about the product or wishes to purchase the product, the user may manipulate the terminal device 300 to select an item in the shopping mall list in the product sales information.

If the user selects a certain item in the shopping mall list in the product sales information (S325), the terminal device 300 may be connected to a detailed information page for the product or an ordering/shopping-cart page where the user can order the product in the electronic commerce server 500 operating a corresponding online shopping mall (S326).

To this end, the information provided in the augmented reality may include a hyperlink for a connection to a corresponding page of each online shopping mall.

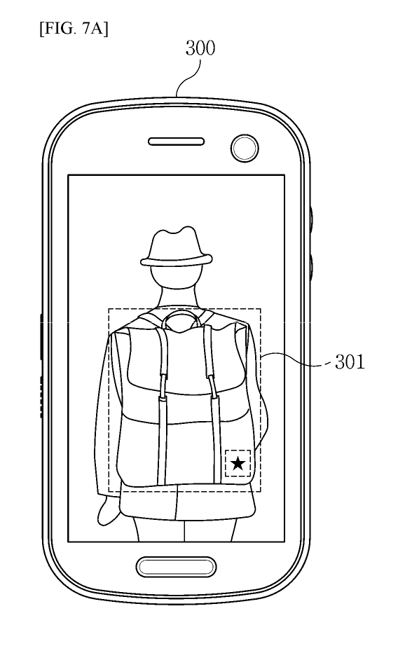

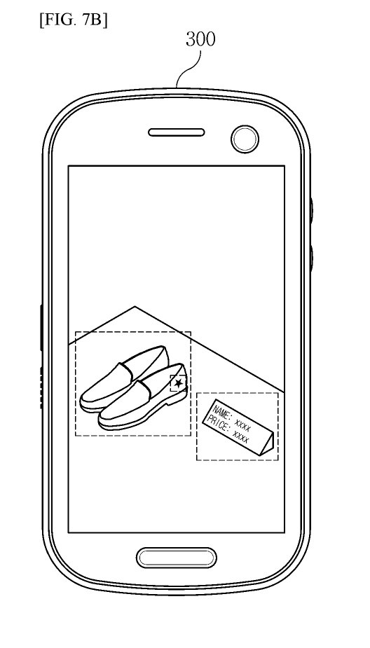

FIGS. 7A and 7B are exemplary offline product images of which online sales information are to be provided based on the augmented reality.

FIG. 7A is an image captured by the user for a product worn by another person on the street by use of the camera unit 320 of the terminal device 300.

At this time, a separate guide line 301 may be displayed on the activated camera so that the user may position the product within a certain frame of the camera. The user may move the terminal device 100 such that the product reside safely within the frame along with the guide line.

The guide line 301 may be set for the product as well as for a trademark attached on the product.

FIG. 7B is an image captured by the user for a product displayed in the offline store by use of the camera unit 320 of the terminal device 300. As described above, the terminal device 300 may provide guide lines for the product itself and the trademark of the product. Further, the terminal device 300 may further provide a guide line for the tag attached on the product in order to facilitate a recognition of the tag.

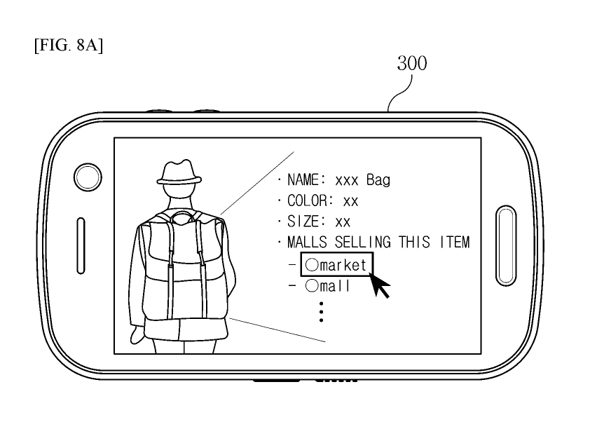

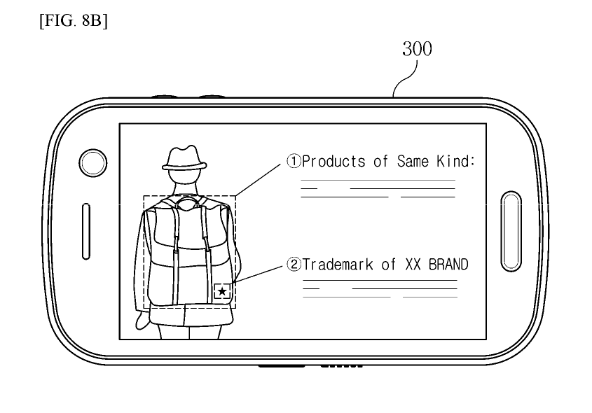

FIGS. 8A and 8B are exemplary screenshots providing the product sales information based on augmented reality according to an embodiment of the present disclosure.

Referring to FIG. 8A, the product information may be combined with the offline product image captured by the user of the terminal device 300 to be displayed in the augmented reality.

The information provided at this time may include the product name, the product color, the product size, and the list of online shopping malls selling the product. If the user needs more information about the product or wants to purchase the product, the user may select one of the online shopping malls in the list.

Referring to FIG. 8B, a list of the products of the same kind as the offline product, that is, products which are the same as or similar to the offline product may be provided in the augmented reality. Also, the trademark attached on the product may be analyzed and a list of the products of the same trademark or brand may be provided in the augmented reality. Further, the user may designate more conditions for the desired product to narrow down the products contained in the list.

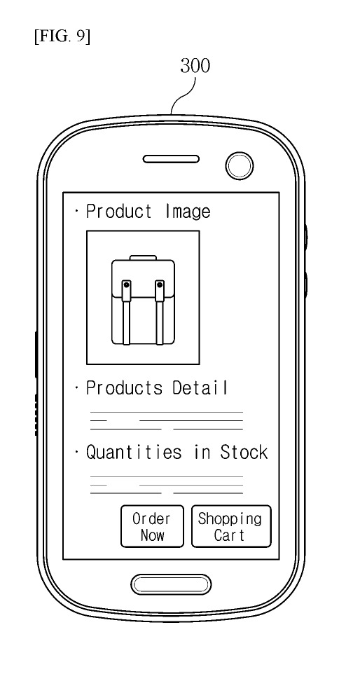

FIG. 9 is an exemplary screenshot of a page provided after an online shopping mall is selected according to an embodiment of the present disclosure.

Referring to FIG. 9, the user of the terminal device 300 may select any one of the online shopping malls selling the products from the product sales information received from the product information providing server 400 to receive a detailed product information page or an ordering/shopping-cart page where the user can order the product.

The detailed product information page may be provided by the product information providing server 400 based on the information stored in its database. Alternatively, the detailed product information page may be provided by the electronic commerce server 500 associated with a corresponding online shopping mall.

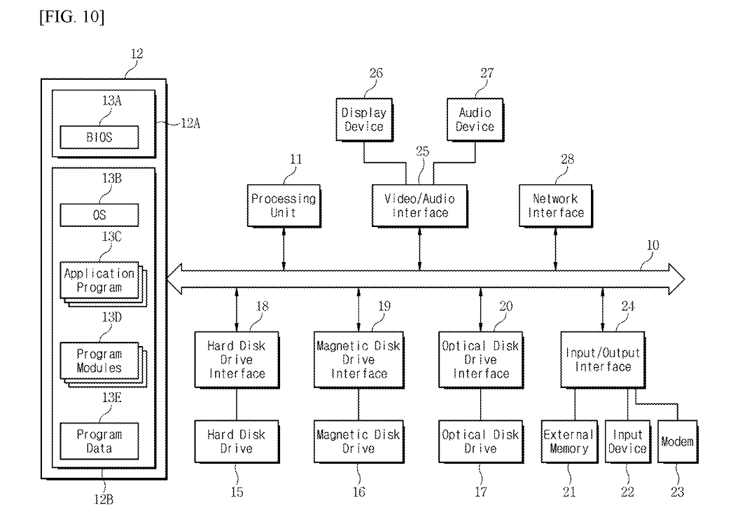

FIG. 10 is a block diagram illustrating an operating environment of a device for providing the product sales information based on augmented reality according to an embodiment of the present disclosure.

FIG. 10 and the following description are intended to provide a brief and general description of a suitable computing environment in which the present disclosure may be implemented. Although it is not required, the present disclosure may be described in connection with computer-executable instructions such as program modules that may be executed by a computer system. Generally, the program modules include routines, programs, objects, components, data structures, and so on suitable for performing particular tasks or implementing particular abstract data types. The computer-executable instructions, associated data structures, and program modules exemplify the program code means for carrying out processes described herein.

Referring to FIG. 10, an exemplary computing system suitable for implementing the present disclosure may include a processing unit 11, a system memory 12, and a system bus 10 that connects various system components including the system memory 12 to the processing unit 11.

The processing unit 11 is capable of executing computer-executable instructions designed to implement the features of the present disclosure.

The system bus 10 may be any of several types of bus architectures including a local bus, an external bus, and a memory bus. Alternatively, the system bus 10 may be any of the bus architectures employing a memory controller. The system memory 12 includes a read-only memory (ROM) 12A and a random access memory 12B. A Basic Input/Output System (BIOS) 13A which includes basic routines that help information transfer between components within the computing system when the system is booted may generally be stored in the ROM 12A.

The computing system may include storage devices. For example, the computing system may include a hard disk drive 15 that reads information from or writes information to a hard disk, a magnetic disk drive 16 that reads information from or writes information to a magnetic disk, and an optical disk drive 17 that reads information from or writes information to an optical disk such as a CD-ROM and other optical medium. The hard disk drive 15, the magnetic disk drive 16, and the optical disk drive 17 may be connected to the system bus 10 by a hard disk drive interface 18, a magnetic disk drive interface 19, and an optical drive interface 20, respectively.

Also, the computing system may further include an external memory 21 as one kind of the storage device. The external memory 21 may be connected to the system bus 10 through an input/output (I/O) interface 24.

The above-described drives and the computer-readable media that may be accessed by the drives allows nonvolatile storage of computer-executable instructions, data structures, program modules, and other data. The exemplary environment described herein illustrates the hard disk 15, the magnetic disk 16, and the optical disk 17, but other types of computer-readable media for storing data such as a magnetic cassette, a flash memory card, a DVD, a Bernoulli cartridge, a RAM, and a ROM may be used as well.

The program code means including one or more program modules that may be loaded and executed by the processing unit 11 and includes an operating system 13B, one or more application programs 13C, other program modules 13D, and program data 13E may be stored in the hard disk 15, the magnetic disk 16, the optical disk 17, the ROM 12A or the RAM 12B.

Also, the computing system may receive commands and information from a user through input devices 22 such as a keyboard, a pointing device, a microphone, a joystick, a game pad, and a scanner. These input devices 22 may be connected to the processing unit 11 via the I/O interface 24 connected to the system bus 10. The I/O interface 24 may logically represent at least one or a combinations of various interfaces such as, for example, a serial port interface, a PS/2 interface, a parallel port interface, a USB interface, an Institute of Electrical and Electronics Engineers (IEEE) 1394 interface (i.e., FireWire interface), and other interfaces.

In addition, the computing system may further include a display device 26 such as a monitor and a liquid crystal display (LCD), and an audio device 27 such as a speaker and a microphone. The display device 26 and the audio device 27 may be connected to the system bus 10 through a video/audio interface 25. Other peripheral devices (not shown) such as a speaker and a printer, for example, may be connected to the computing system. The video/audio interface 25 may include a High Definition Multimedia Interface (HDMI) and Graphics Device Interface (GDI).

The computing system may be connected to a network such as, for example, an office wide area network (WAN) or an enterprise WAN, a home network, Intranet, and/or Internet. The computing system may exchange data with external sources such as, for example, a remote computer system, a remote application, and/or a remote database.

To this end, the computing system may include a network interface 28 for receiving data from an external source and/or transmitting data to the external source.

The computing system may transmit and receive information to and from a remote device through the network interface 28. For example, in case that the computing system refers to the terminal device 300, the computing system may communicate with the product information providing server 400 through the network interface 28. On the other hand, in case that the computing system refers to the product information providing server 400, the computing system may exchange information with the terminal device 300 through the network interface 28. The network interface 28 may represent a network interface card, or an equivalent software such as a network driver interface specification (NDIS) stack, an equivalent hardware, and/or a logical combination of the software and hardware.

Likewise, the computing system may transmit and receive data to and from an external source through the I/O interface 24. The I/O interface 24 may be connected to a modem 23 such as a standard modem, a cable modem, and a digital subscriber line (DSL) modem. The computing system may transmit and receive data to and from the external source through the modem 23.

Although FIG. 10 shows an operating environment suitable for the present disclosure, the principles of the present disclosure may be applicable to any other system capable of implementing the principles of the present disclosure with appropriate modifications, if necessary. The environment shown in FIG. 10 is illustrative only and does not represent even a small portion of various environments in which the principles of the present disclosure may be implemented.

In addition, various information generated during the execution of the program according to the present disclosure may be stored and accessed in a computer-readable medium related with the computing system. For example, a portion of these program modules and a portion of the associated program data may be included in the operating system 13B, the application program 13C, the program module 13D, and/or the program data 13E to be stored in the system memory 12.

Further, when a mass storage device such as the hard disk is connected to the computing system, such program module and related program data may be stored in the mass storage device. In a networked environment, the program modules associated with the present disclosure, or portions thereof, may be stored in a remote computer system (e.g. a system memory related with a computing system of the terminal device 300, or a remote memory device such as a mass storage device) connected via the I/O interface 24 and the modem 23 or the network interface 25. The execution of such a module may be performed in a distributed environment as described above.

According to the present disclosure, when the user wishes to acquire information of a certain product, the user may receive the product information, searched for products the same as or similar to the certain product, simply by capturing an image of the certain product instead of inputting all the clue information of the product. Also, since the product information is provided in the augmented reality, the user may receive the product information in a more immersive form.

While the present specification contains a number of specific implementation details, it should be understood that they are not to be construed as limitations on the scope of any disclosure or claims, but as a description of features that may be specific to a particular embodiment of a particular disclosure. Certain features described with respect to contexts of independent embodiments may be implemented in combination in a single embodiment. Conversely, various features described in the context of a single embodiment may also be implemented in other embodiments either individually or in any suitable sub-combination. Further, although some features may be described to operate in a particular combination and may be initially depicted as so claimed, one or more features from the claimed combination may in some cases be excluded from the combination, and a claimed combination may be replaced by a sub-combination or a variant of the sub-combination.

Similarly, although the operations are depicted in the drawings in a particular order, it should not be understood that such operations need to be performed in that particular order or sequential order shown to achieve the desired result or all the depicted operations should be performed. In certain cases, multitasking and parallel processing may be advantageous. Also, the fragmentation of the various system components in the above-described embodiments should not be understood as requiring such fragmentation in all embodiments, and the program components and systems described above may generally be integrated together into a single software product or packaged into a multiple-function software product.

Although specific embodiments of the subject matter have been described herein, other embodiments are within the scope of the following claims. For example, the operations defined in the claims may be performed in a different order to still achieve desirable results. By way of example, the process illustrated in the accompanied drawings does not necessarily require that particularly illustrated sequence or sequential order to achieve the desired result. In certain implementations, multitasking and parallel processing may be advantageous.

The descriptions set forth above disclose the best mode of the present disclosure, and is provided to illustrate the disclosure and to enable those skilled in the art to make and use the disclosure. The written description is not intended to limit the disclosure to the specific terminology presented. Thus, although the present disclosure has been described in detail with reference to the above examples, those skilled in the art will be able to make adaptations, modifications, and variations on the examples without departing from the scope of the present disclosure.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A product information providing server, comprising:
a service communication unit configured to transmit and receive data to and from at least one terminal device and at least one electronic commerce server through a communication network;
a service search unit configured to extract offline product information by analyzing an offline product image of an offline product, and acquire online product sales information corresponding to the extracted offline product information; and
a service controller configured to control the service search unit to perform an image-based search to find an online-sold product corresponding to the offline product when the offline product image is received from the terminal device through the service communication unit, and provide the terminal device with the online product sales information acquired by the service search unit.

2. The product information providing server of claim 1, wherein when the service controller receives a user's selection of an online-sold product indicated in the online product sales information from the terminal device after providing the online product sales information, the service controller provides the terminal device with a product purchasing page or a shopping cart page for the selected online-sold product in cooperation with the electronic commerce server.

3. The product information providing server of claim 1, wherein the service search unit extracts at least one of characteristics information of the offline product image, trademark information contained in the offline product image, price information of the offline product, and color information of the offline product as the offline product information.

4. The product information providing server of claim 3, further comprising:
a service storage unit configured to store characteristics information of images for one or more online-sold products sold by one or more electronic commerce servers through the communication network,
wherein the service search unit searches at least one online-sold product the same as or similar to the offline product by comparing the characteristics information of images of the online-sold products stored in the service storage unit with the offline product image, and acquires the sales information of the extracted online-sold product from the electronic commerce server.

5. A terminal device, comprising:
a communication unit configured to transmit and receive data through a communication network;
a camera unit configured to take a captured image in response to a control command;
an input unit configured to receive a user command; and
a controller configured to activate the camera unit in response to the user command to take an offline product image of an offline product, transmit the offline product image to a product information providing server through the communication unit, receive online product sales information corresponding to the offline product image from the product information providing server through the communication unit, and output the online product sales information with the offline product image in augmented reality.

6. The terminal device of claim 5, wherein, when outputting the sales information of the online-sold product in the augmented reality, the controller arranges the sales information of the online-sold product based on the offline product image in a captured image containing the offline product image,
wherein a user interface allowing a user to select one item in the sales information of the online-sold products is output in addition to the sales information of the online-sold product and the online-sold product.

7. The terminal device of claim 6, wherein, when an item in the sales information of the online-sold products is selected through the user interface, the controller transmits selection information to the product information providing server, and receives and displays a product purchasing page or a shopping cart page for a selected online-sold product.

8. A method of providing product sales information based on augmented reality in a terminal device capable of accessing a product information providing server through a communication network, the method comprising:
activating a camera function according to a user command to take an offline product image of an offline product;
transmitting the offline product image to a product information providing server;
receiving online product sales information corresponding to the offline product image from the product information providing server; and
outputting the online product sales information with the offline product image in the augmented reality.

9. The method of claim 8, further comprising:
providing a user interface allowing a user to select one item in the sales information of the online-sold products in the outputting operation in addition to the sales information of the online-sold product and the online-sold product, and transmitting selection information to the product information providing server when the user select an item in the sales information of the online-sold products through the user interface; and
receiving, from the product information providing server, and displaying a product purchasing page or a shopping cart page for a selected online-sold product.
